(19) United States
(12) Patent Application Publication
(10) Pub. No.: US 2009/0013044 A1
(43) Pub. Date: Jan. 8, 2009

(54) Techniques for managing annotation transformations for context changes

(75) Inventor: Ben Stull, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/825,185

(22) Filed: Jul. 5, 2007

(51) Int. Cl. G06F 15/16

(52) U.S. Cl. 709/205

(57) ABSTRACT

Techniques for managing annotation transformations are described. An apparatus may include a processor coupled to memory. The memory may store a shared application manager (SAM) module for execution by the processor. The SAM module may comprise a client user interface component operative to generate a shared application view for a shared application object. The SAM module may also include an annotations manager operative to associate an annotation object with the shared application object, detect a change in context for the shared application view, and transform the annotation object in accordance with the context change. Other embodiments are described and claimed.

### BACKGROUND

Collaborative software attempts to provide services for users to achieve a common goal. Application sharing is an element of remote access that enables two or more users to access a host's desktop, such as a shared application or document, from their respective computers substantially simultaneously in real-time. Generally, the shared application or document will be running on a host computer, and remote access to the shared content will be provided to other users by the host user. Control of the shared application or document is typically held by the host user, and may be passed to the remote users under authorization of the host user.

In some cases, the host user and the remote users may provide notes, marks or annotations on the shared application or document. For example, a remote user might highlight a portion of a shared document using an input device such as a mouse during a collaboration session, where the changes to the shared document are displayed by all participants in the collaboration session. Such user-provided annotations, however, are usually temporary, static, and generally unmanaged by the collaboration software. Given the dynamic nature of collaboration operations performed using online tools, collaborative software tools should be sufficiently robust to respond to changes in the online environment. Consequently, there may be a substantial need for improvements in collaboration software and application sharing software to solve these and other problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments may be generally directed to communications systems. Some embodiments may be particularly directed to collaboration software to allow remote users to share applications over a communications system or network. More particularly, some embodiments are directed to techniques for managing annotation transformations during context changes to the shared applications. In one embodiment, for example, an apparatus such as a computing device may include a processing system having at least a processor coupled to memory. The memory may store a shared application manager (SAM) module for execution by the processor. The SAM module may comprise a client user interface component operative to generate a shared application view for a shared application object. The SAM module may also include an annotations manager operative to associate an annotation object with the shared application object, detect a change in context for the shared application view, and transform the annotation object in accordance with the context change. Examples of such annotation transformations may include storing annotations, retrieving annotations, deleting annotations, moving annotations, performing size modifications for the annotations, and so forth. Other embodiments are described and claimed.

### BRIEF DESCRIPTION OF THE DRAWINGS

FIG. 1 illustrates one embodiment of a communications system.

FIG. 2 illustrates one embodiment of shared application manager module.

FIG. 3 illustrates one embodiment of a shared application display.

FIG. 4 illustrates one embodiment of a logic flow.

FIG. 5 illustrates one embodiment of a computing system architecture.

### DETAILED DESCRIPTION

Various embodiments may comprise one or more elements. An element may comprise any feature, characteristic, structure or operation described in connection with an embodiment. Examples of elements may include hardware elements, software elements, physical elements, or any combination thereof. Although an embodiment may be described with a limited number of elements in a certain arrangement by way of example, the embodiment may include more or less elements in alternate arrangements as desired for a given implementation. It is worthy to note that any references to “one embodiment” or “an embodiment” or similar language are not necessarily referring to the same embodiment.

Various embodiments may be directed to collaboration software to allow remote users to share applications over a communications system or network. Some embodiments are directed to techniques for managing annotation transformations during context changes to the shared applications. Some types of collaboration software allow users participating in the collaboration session to annotate documents, web pages or other content for the shared application. The annotations may be in the form of marks, notes, highlighting, drawn lines, and so forth. Such user-provided annotations, however, are usually temporary, static, and generally unmanaged by the collaboration software. For example, as the underlying content changes the corresponding annotations generally remain the same. To solve these and other problems, some embodiments implement an annotations manager to manage annotations in response to context changes to the underlying content for the shared application. The annotation manager may be arranged to detect context changes, and perform various types of annotation transformation operations. Examples of annotation transformation operations may include without limitation storing annotations, retrieving annotations, deleting annotations, moving annotations, performing size modifications for the annotations, and so forth. In this manner, some embodiments may dynamically manage annotations to adapt to changes in the underlying shared applications to which the annotations apply, thereby leading to more robust collaborative efforts among the remote users sharing an application.

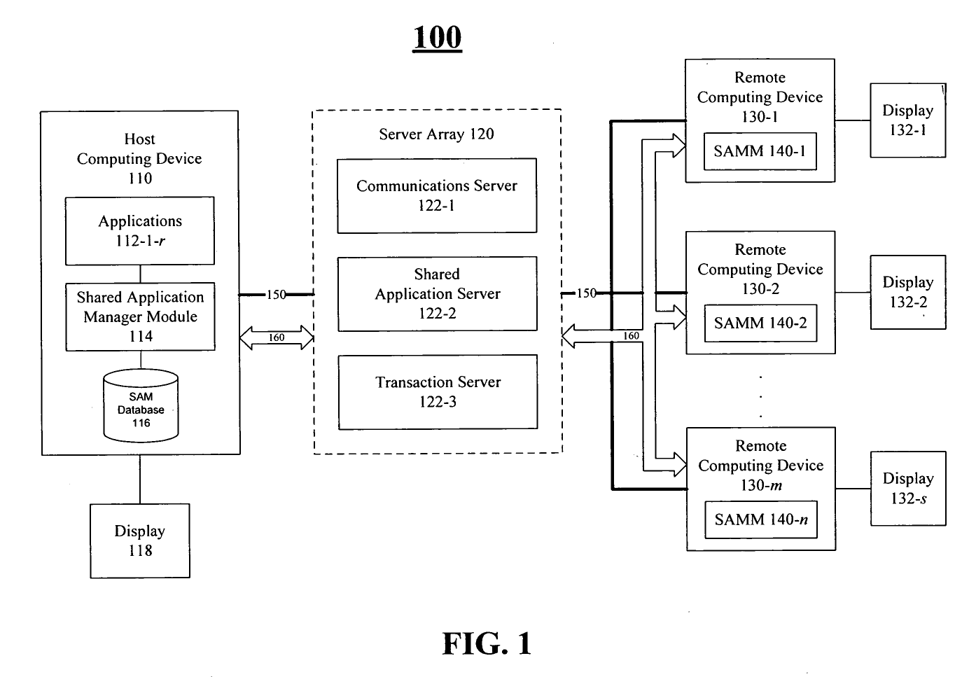

FIG. 1 illustrates a block diagram of a communications system 100. In various embodiments, the communications system 100 may be implemented as a wireless communication system, a wired communication system, or a combination of both. When implemented as a wireless communication system, communications system 100 may include components and interfaces suitable for communicating over wireless communications media, such as one or more antennas, transmitters, receivers, transceivers, amplifiers, filters, control logic, and so forth. An example of the communications media may include a wireless shared media implemented using portions of a wireless spectrum, such as the radio-frequency (RF) spectrum and so forth. When implemented as a wired communications system, communications system 100 may include components and interfaces suitable for communicating over wired communications media, such as input/output (I/O) adapters, physical connectors to connect the I/O adapter with a corresponding wired communications medium, network interfaces, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

As shown in the illustrated embodiment of FIG. 1, the communications system 100 may include a host computing device 110, a server array 120 and multiple remote computing devices 130-1-m, all connected via communications media 150. The communications media 150 may represent wired communications, wireless communication media, or a combination of both. The host computing device 110 may further include various application programs 112-1-r, a shared application manager (SAM) module 114, a shared application database 116, and a display device 118. The server array 120 may further comprise multiple servers 122-1-s, such as a communications server 122-1, a shared application server 122-2 and a transaction server 122-3. The remote computing devices 130-1-m may each comprise a shared application client module 140-1-n and display 132-1-s. Although FIG. 1 illustrates a limited number of elements in a given topology, it may be appreciated that the communications system 100 may include more or less elements in different topologies and still fall within the scope of the embodiments. The embodiments are not limited in this context.

In one embodiment, the communications system 100 may include the host computing device 110. The host computing device 110 may comprise any electronic device having a processing system and appropriate network interfaces to communicate information over a network, such as a packet-switched network, a circuit-switched network, or a combination of both. Examples of a packet-switched network may comprise an Internet Protocol (IP) network or the Internet. An example of a circuit-switched network may comprise the Public Switched Telephone Network (PSTN). Information may be communicated across both types of networks using gateways and other internetworking devices. Examples of the host computing device 110 may include without limitation a processing system, computer, server, work station, appliance, terminal, personal computer, laptop, ultra-laptop, handheld computer, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof.

In one embodiment, for example, the host computing device 110 may further include various application programs 112-1-r. The application programs 112-1-r may comprise any desired application program suitable for execution by the host computing device 110. Application software is generally a subclass of computer software that employs the capabilities of a computer directly to a task that the user wishes to perform. This should be contrasted with system software which is involved in integrating a computer's various capabilities, but typically does not directly apply them in the performance of tasks that benefit the user. In this context the term application refers to both the application software and its implementation. Examples of application programs 112-1-r may include without limitation various type of application programs from the MICROSOFT® OFFICE suite of application programs, including MICROSOFT WORD, MICROSOFT EXCEL®, MICROSOFT OUTLOOK®, MICROSOFT VISIO®, MICROSOFT POWERPOINT®, MICROSOFT ONENOTE®, MICROSOFT PROJECT, MICROSOFT INTERNET EXPLORER®, and so forth, as made by Microsoft Corporation, Redmond, Wash.

In one embodiment, for example, the host computing device 110 may further include the display device 118. The display device 118 may comprise any electronic display capable of displaying multimedia signals from the host computing device 110. Examples of the display device 118 may include cathode ray tube (CRT) monitors, a liquid crystal display (LCD), thin film transistor (TFT) displays, electronic paper, plasma display panels, organic light-emitting diode (OLED) displays, a surface-conduction electron-emitter display (SED), carbon nanotube displays, nanocrystal displays, movie projectors, digital projectors, televisions, digital televisions, laser televisions, and so forth.

In one embodiment, the communications system 100 may include one or more remote computing devices 130-1-m. The remote computing devices 130-1-m are similar to the host computing device 110, and are typically geographically separate from the hosting computing device 110. Similar to the host computing device 110, the remote computing devices 130-1-m may comprise any electronic device having a processing system and appropriate network interfaces to communicate information over a network, such as a packet-switched network, a circuit-switched network, or a combination of both. Examples of the remote computing devices 130-1-m may include some or all of the examples previously provided for the host computing device 110.

In various embodiments, the computing devices 110, 130 may each be arranged with collaborative software designed to allow the communicating devices 110, 130 to perform application sharing. Application sharing is an element of remote access that enables two or more users to access a shared application, document, content or object from their respective computing devices 130-1-m substantially simultaneously in real-time. Generally, the shared application will be running on the host computing device 110, and remote access to the shared content will be provided to other users via the remote computing devices 130-1-m by the host user. The host user typically controls the shared content, and may share control with the remote users under the authorization and supervision of the host user.

In illustrated embodiment of FIG. 1, for example, the host computing device 110 may include SAM module 114, and the remote computing devices 130-1-m may each include SAM modules 140-1-n. In some cases the SAM modules 114, 140 may be the same or similar application programs designed to work together or separately to facilitate application sharing between the computing devices 110, 130. In other cases, the SAM modules 114, 140 may be different application programs designed to interoperate with each other to facilitate application sharing between the computing devices 110, 130. In general operation, the SAM module 114 may allow a host user to control a collaboration session established between the computing devices 110, 130. The SAM modules 140-1-n may allow remote users to join in the collaboration session established between the computing device 110, 130, and in some cases control the collaboration session under the authorization and supervision of the host user.

In one embodiment, for example, the SAM modules 114, 140 may be implemented as various software components of a MICROSOFT SHAREDVIEW application program. The MICROSOFT SHAREDVIEW application program allows multiple users to access and share a shared view of a shared view object via a web browser, such as MICROSOFT INTERNET EXPLORER. For example, the MICRSOFT SHAREDVIEW application program allows multiple users to join a collaboration session established by the host computing device 110 over a packet network, such as the Internet, and view the shared content via a web browser graphics user interface (GUI) window. The embodiments are not limited, however, to this exemplary implementation.

In various embodiments, the communications system 100 may include the server array 120. The server array 120 may comprise one or more infrastructure servers 122-1-s to facilitate and support collaboration operations or application sharing for the computing devices 110, 130. In one embodiment, the servers 122-1-s may be implemented in accordance with the MICROSOFT SHAREDVIEW server architecture to support the MICROSOFT SHAREDVIEW application programs of the computing devices 110, 130. For example, the server array 120 may include the communications server 122-1, the shared application server 122-2 and the transaction server 122-3. The communications server 122-1 may be arranged to manage collaborative sessions between the computing devices 110, 130. This may include establishing collaborative sessions, authenticating participants, adding participants, deleting participants, disestablishing collaborative sessions, and other connection or session management operations. The shared application server 122-2 may be arranged to manage application sharing operations between the computing devices 110, 130. The transaction server 122-3 may be arranged to manage e-commerce operations, such as subscriptions, secure transactions, payment processing, and so forth.

In general operation, the communications system 100 may allow multiple users to perform multimedia collaboration over a network to share an application. For example, a host user may use the host computing device 110 to establish a collaboration session with remote computing devices 130-1-m via the server array 120 over communications media 150. Once the collaboration session has been established, and the remote computing devices 130-1-m have joined the collaboration session, the host computing device 110 may display a shared view object in a shared view window of the GUI on the display 118. Examples of a shared view object may include any content or information from the applications 112-1-r that may be displayed by the shared view window, including documents, spreadsheets, slides, web pages, notes, calendars, email, and so forth. The shared view window may comprise a GUI window generated by an operating system (OS) of the computing device 110. For example, the shared view window may comprise a web browser window generated for the MICROSOFT INTERNET EXPLORER internet browser. The host user and the remote users may simultaneously view the shared view object in a shared view window on their respective display devices 118, 132 via a shared view media stream 160. Further, a user that is currently in control of the collaboration session may make modifications to the shared view object. This is typically the host user, but the host user may pass control to any of the remote users when desired. When any changes are made by a controlling user to the shared view object, the changes are propagated to the other participants in the collaboration session in substantially real-time, and updated on their shared view window. In this manner, multiple users may work on the shared view object in real-time even though they are geographically remote from each other.

In some cases, the host user and the remote users may provide notes, marks or annotations on the shared view object via the SAM modules 114, 140. The SAM modules 114, 140 may provide each computing device with various user interface tools to markup or annotate the shared view object during a collaboration session, where the changes to the shared view object are displayed by all participants in the collaboration session. For example, the MICROSOFT SHAREDVIEW application program assigns each user a different color that may be used to highlight various portions of the shared content. The annotations, referred to as “telepointers” in the MICROSOFT SHAREDVIEW lexicon, may then be replicated to the displays 132-1-s of the other users. As used herein, the term “annotations” may comprise any number of different annotation objects suitable for reproduction on a display, such as the displays 118, 132. Examples for the annotation objects may include text, numbers, symbols, images, pictures, animations, video, graphics, audio files, video files, notes, icons and so forth. Furthermore, the annotation objects may have varying degrees of transparency, translucency or opaqueness to allow a user to view background objects behind a given annotation object.

In many cases, such user-provided annotations are usually temporary, static, and generally unmanaged by the collaboration software. For example, when the controlling user changes the content or context of their application, the previous annotations may persist even though they are not longer relevant to the new shared view object. For instance, if a new shared view object such as a document is loaded into the application program 112-1-r, the existing annotations displayed on the displays 118, 132 persist to the new document instead of clearing. In some cases, some conventional techniques may use time progression to cause annotations to fade away over time. Such fading deletions, however, are typically performed without reference to any context changes to the underlying context. In another example, if a controlling user scrolls up or down on a shared view object such as a document, the annotations remain static and do not move with the document. In yet another example, if a controlling user zooms in to make a portion of the document larger, the size of the annotation windows used to display the annotation remain the same. In still another example, if the controlling user navigates to a new shared view object, and then returns, the annotation objects may be lost and irretrievable. Given the dynamic nature of collaboration operations performed on a shared view object using online tools, collaborative software tools should be sufficiently robust to respond to changes in the online environment, particularly with respect to treatment of annotations to a shared view object.

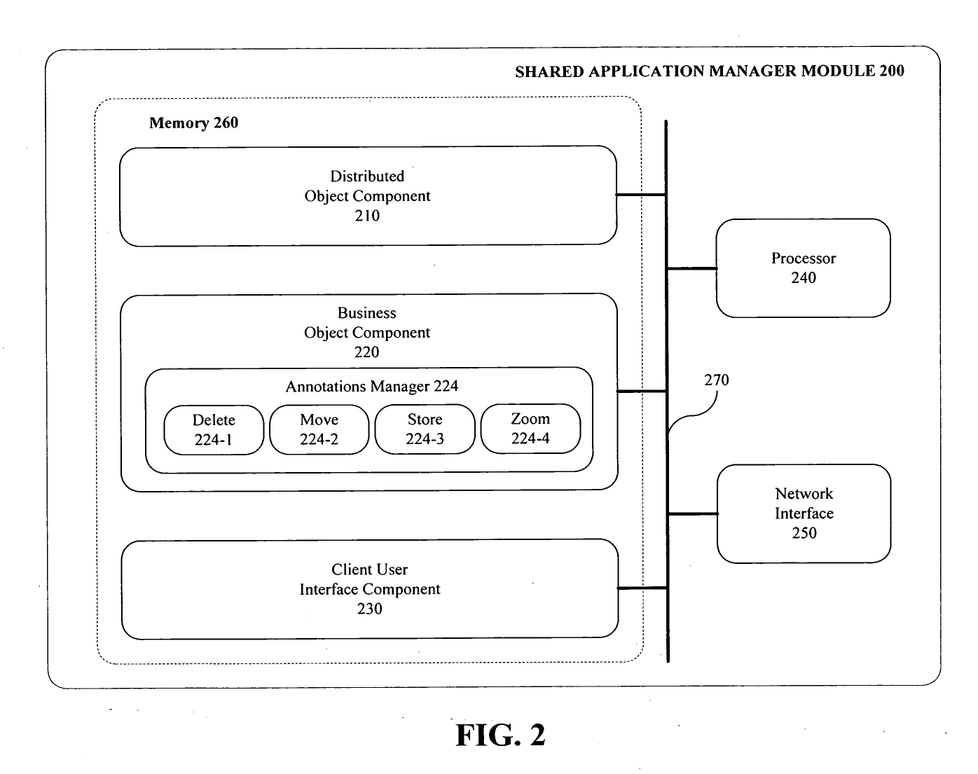

To solve these and other problems, the SAM modules 114, 140 of the respective computing devices 110, 130 may implement techniques for managing annotations during context changes or transformations of the underlying shared content or shared view objects. The SAM modules 114, 140 may be arranged to detect certain context changes for a shared view object in a shared view window, and transform any annotations disposed on the shared view object or shared view window in accordance with the change in context. In one embodiment, for example, an apparatus such as a computing device may include a processor and memory unit. The memory unit may store a SAM module for execution by the processor. The SAM module may comprise a client user interface component operative to generate a shared application view for a shared application object. The SAM module may further comprise an annotations manager operative to associate an annotation object with the shared application object, detect a change in context for the shared application view, and transform the annotation object in accordance with the context change. In this manner, the annotations manager may dynamically manage annotations for a collaboration session to adjust for changes in context during the collaboration session. The communications session 100 in general, and the SAM modules 114, 140 in particular, may be described in more detail with reference to FIGS. 2-5.

FIG. 2 illustrates one embodiment of SAM module 200. The SAM module 200 may be representative of, for example, the SAM modules 114 and/or 140 implemented with the respective computing devices 110, 130. As shown in FIG. 2, the SAM module 200 may comprise a processor 240, a network interface 250 and a memory 260, all connected via a bus 270. The memory 260 may include various software components and data, including a distributed object component 210, a business object component 220, and a client user interface component 230. The business object component 220 may further comprise an annotations manager 224. The annotations manager 224 may further comprise a delete module 224-1, a move module 224-2, a store module 224-3, and a zoom module 224-4. Although FIG. 2 illustrates a limited number of elements in a given topology, it may be appreciated that the SAM module 200 may include more or less elements in different topologies and still fall within the scope of the embodiments. The embodiments are not limited in this context.

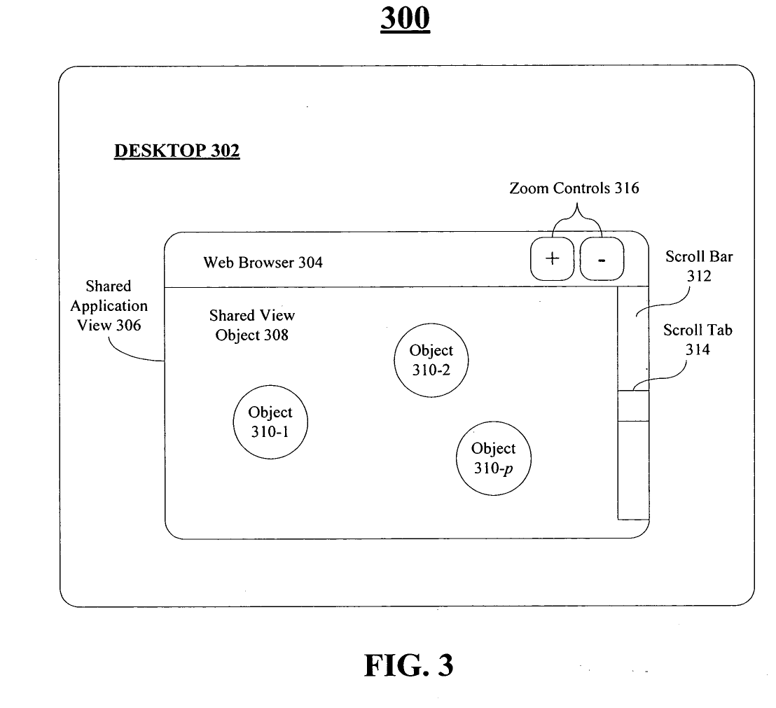

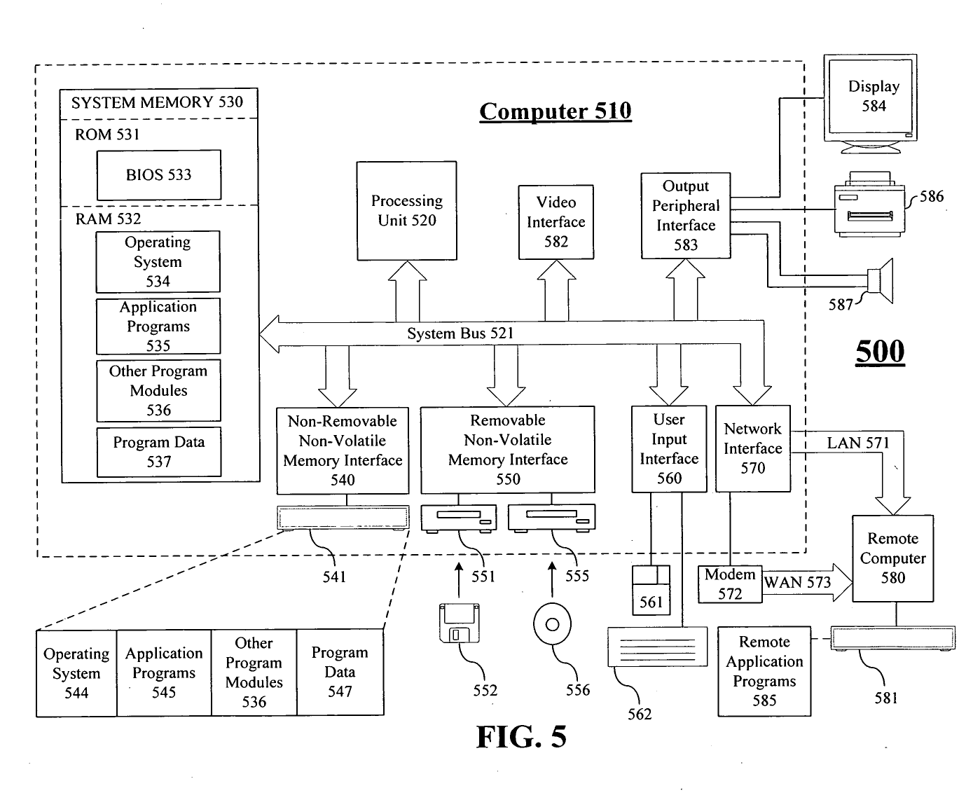

In various embodiments, the SAM module 200 may be implemented for the host computing device 110 or any of the remote computing devices 130-1-m. Examples for the processor 240, network interface 240, memory 260 and bus 270 may be described in more detail with reference to FIG. 5. The distributed object component 210 may implement a distributed object layer to manage distributed objects for a collaboration session. Examples of distributed objects may include shared view objects displayed by a shared view window, as described in more detail with reference to FIG. 3. The business object component 220 may expose the distributed objects managed by the distributed object component 210 to the client user interface component 230. The client user interface component 230 may generate and display the distributed objects, including any annotations made for the distributed objects. The client user interface component 230 may use the GUI for the OS or have its own GUI components and controls.

In various embodiments, the SAM module 200 may include the annotations manager 224. In some embodiments, the annotations manager 224 may be implemented as part of the business object component 220. In other embodiments, the annotations manager 224 may be implemented in another part of the collaboration software architecture, including as a stand alone module. The annotations manager 224 may manage and control annotations for a shared application. For example, the annotations manager 224 may transform annotations for a shared view object and/or a shared view window in accordance with context changes made to the shared view object and/or the shared view window. In general, whenever an annotation is made to a shared view object or the shared view window by a user of the computing devices 110, 130, the annotations manager 224 associates the annotation with the shared view object, and stores the associated annotation in the SAM database 116. The annotations manager 224 monitors the shared view object or the shared view window used to display the shared view object for any context changes. When a context change is detected, the annotations manager 224 modifies, changes state or otherwise transforms the annotations associated with the shared view object in accordance with the context change. Based on the type of context change, the annotations manager 224 may utilize or call the delete module 224-1, the move module 224-2, the store module 224-3, and the zoom module 224-4 to transform the annotations. The modules 224-1-4 and corresponding annotation transformation operations may be described in more detail with reference to FIG. 3.

FIG. 3 illustrates one embodiment of a shared application display 300. The shared application display 300 may be representative of a GUI view for the SAM module 200 as displayed by the display devices 118, 132. As shown in FIG. 3, the shared application display 300 may illustrate a GUI view of a desktop 302 for the OS executed by the computing device 110, 130. Assume a user launches an application 112-1-r of the host computing device 110 comprising a web browser such as MICROSOFT INTERNET EXPLORER. The OS may generate a GUI window for web browser 304 to display a shared view object 308 such as a web page. An example of a web page may include a Hypertext Markup Language (HTML), Extensible Markup Language (XML) document, and so forth. The user may also launch the SAM module 114 to establish a collaboration session for the remote computing devices 130-1-m via the server array 120. The remote computing devices 130-1-m may join the collaboration session, and begin viewing the web browser window 304 and the shared view object 308. Assume during the collaboration session a remote user for the remote computing device 130-1 desires to highlight a portion of the web page (e.g., shared view object 308). The host user for the host computing device 110 may assign control of the collaboration session to the remote user of the remote computing device 130-1. The remote user may then begin annotating the shared view object 308 with annotation objects 310-1-p. The annotations objects 310-1-p are then scraped by the SAM module 114, and sent to the other remote computing devices 130-1-m via the shared view media stream 160 to update their respective displays 132-1-s.

Referring again to FIG. 2, in one embodiment the annotations manager 224 may include a delete module 224-1. The delete module 224-1 may be arranged to delete an annotation object 310-1-p from a shared application view 306 when a shared application object 308 is no longer within the shared application view 306. Continuing with the previous example, assume the host user resumes control of the collaboration session, and decides to navigate to a new web page. The annotation objects 310-1-p may not be relevant to the new web page. In this case, the annotations manager 224 may detect a context change for the existing web page in the form of replacement by the new web page. The store module 224-3 of the annotations manager 224 may associate the annotation objects 310-1-p with the shared view object 308, and then store the associated annotation objects 310-1-p in the SAM database 116. The annotations manager 224 may then call the delete module 224-1 to delete the annotation objects 310-1-p from the shared application view 306. In this manner, the annotation objects 310-1-p will not obscure or interfere with viewing of the new web page.

In one embodiment, the annotations manager 224 may include the move module 224-2. The move module 224-2 may be arranged to move the annotation objects 310-1-p in accordance with any movement of the shared application object 308 within the shared application view 306. For example, assume the host user resumes control of the collaboration session, and decides to scroll up or down on the web page using a scroll bar 312 and a scroll tab 314. The host user may scroll the web page using the scroll tab 314 to reveal a different portion of the web page. The annotations manager 224 may detect a context change for the existing web page in the form of scrolling the existing web page. The annotations manager 224 may call the move module 224-2 to move the annotation objects 310-1-p at the same or similar movement rate of the scroll tab 314 so their position remains the same relative to the shared application object 308. In this manner, the annotation objects 310-1-p may scroll with the shared application object 308.

In one embodiment, the annotations manager 224 may include the store module 224-3. As previously described, the store module 224-3 may associate the annotation objects 310-1-p with the shared view object 308, and then store the associated annotation objects 310-1-p in the SAM database 116. The stored annotation objects 310-1-p may be available for later retrieval and use. For example, assume the host user navigates away from the existing web page to a new web page, and then selects the back button on the web browser 304 to return to the existing web page. In this case, the delete module 224-1 will have been called to clear the annotation objects 310-1-p from the shared application view 306 when the existing web page is replaced by the new web page in the shared application view 306. When the host user selects the back button to navigate back to the previous web page, the annotation objects 310-1-p will be missing. The store module 224-3 may retrieve the annotation objects 310-1-p from the SAM database 116 for display by the shared application view 306 when the shared application object 308 is redisplayed by the shared application view 306.

In one embodiment, the annotations manager 224 may include the zoom module 224-4. The zoom module 224-4 may be arranged to modify a size for the annotation objects 310-1-p in accordance with size modifications of the shared application object 308. For example, assume the host user zooms in to magnify or enlarge a portion of the existing web page, or zooms out to decrease or reduce the existing web page, using the appropriate zoom controls 316. The annotations manager 224 may detect a context change for the existing web page in the form of zooming the existing web page. The annotations manager 224 may call the zoom module 224-2 to modify a size for the annotations windows displaying the corresponding annotation objects 310-1-p in proportion to the amount of magnification or reduction provided by the zoom controls 316. In this manner, the annotation objects 310-1-p may maintain substantially the same relative size and perspective as the shared application object 308.

Operations for the communications system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the communications system 100 or alternative elements as desired for a given set of design and performance constraints.

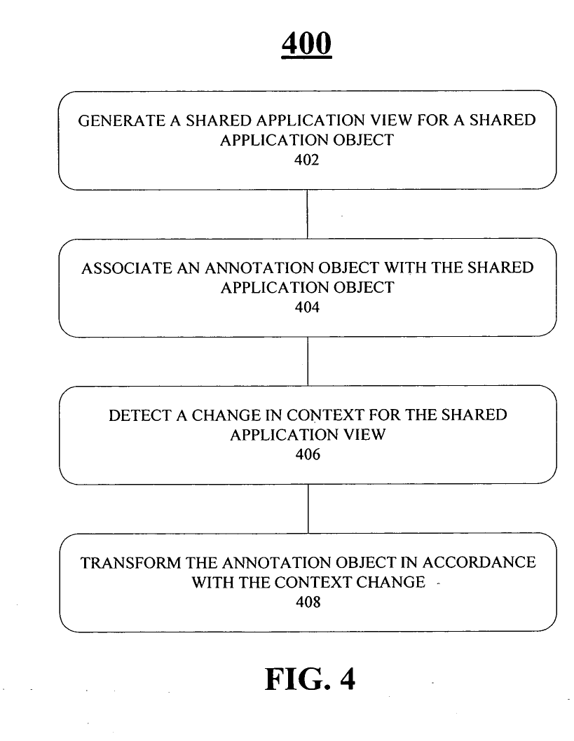

FIG. 4 illustrates a logic flow 400. Logic flow 400 may be representative of the operations executed by one or more embodiments described herein. As shown in FIG. 4, the logic flow 400 may generate a shared application view for a shared application object at block 402. The logic flow 400 may associate an annotation object with the shared application object at block 404. The logic flow 400 may detect a change in context for the shared application view at block 406. The logic flow 400 may transform the annotation object in accordance with the context change at block 408. The embodiments are not limited in this context.

In one embodiment, the logic flow 400 may generate a shared application view for a shared application object at block 402. For example, the SAM module 114 may generate the shared application view 306 for the shared application object 308 for a collaboration session. The shared application view 306 may include any of the GUI elements displayed by the display device 118 of the host computing device 110, ranging from the entire GUI view to a specific GUI window. For example, the shared application view 306 may represent a web browser window for web browser 304, or the entire desktop 302, as desired for a given collaboration session.

In one embodiment, the logic flow 400 may associate an annotation object with the shared application object at block 404. For example, the store module 224-3 of the SAM module 200 may associate the annotation objects 310-1-p with the shared application object 308 in the shared application view 306. The store module 224-3 may perform object association operations at any time during the collaboration session, including when the annotation objects 310-1-p are generated for the shared application object 308, or when the annotations manager 224 detects a context change for the shared application object 308. Factors for such timing decisions may include computational expense, bandwidth expense and latency considerations, among other factors.

In one embodiment, the logic flow 400 may detect a change in context for the shared application view at block 406. For example, the annotations manager 224 may detect a context change for the shared application view 306 or the shared application object 308. A context change for the shared application view 306 may include changes to a given shared application object 308 displayed by the shared application view 306, such as when navigating from one web page or document to another web page or document. A context change for the shared application object 308 may include changes made directly to a given shared application object 308, such as scrolling or zoom operations.

In various embodiments, the annotations manager 224 may detect context changes in a number of different ways. In some embodiments, the shared application object 308 may have an embedded MICROSOFT ACTIVEX® control. In one embodiment, for example, context changes in the form of navigating between web pages may be detected using an ActiveX control and JavaScript. When the shared application object 308 is a web page, the ActiveX control is loaded and called from the web page by the web browser 304. A scripting language such as JavaScript may be used to write functions that are embedded in or included from Hypertext Markup Language (HTML) or Extensible Markup Language (XML) pages and interact with the Document Object Model (DOM) of the page to perform tasks not possible in HTML or XML alone. Some common examples of this usage are opening or popping up a new window with programmatic control over the size, position and “look” of the new window, validation of web form input values to make sure that they will be accepted before they are submitted to a server, changing images as the mouse cursor moves over them, and so forth. The annotations manager 224 may embed a JavaScript in the web page that may be used by the DOM to receive an event, such as when the controlling user navigates to a new web page. This may be accomplished, for example, using the OnLoad event in the HTML Body tag. The event handler loads the ActiveX control and calls the delete module 224-1 to clear any annotation objects 310-1-p currently displayed by the shared application view 306. Alternatively, a plug-in module to the web browser 304 may be used to detect context changes to the shared application view 306 or shared view object 308 as desired for a given implementation.

In one embodiment, the logic flow 400 may transform the annotation object in accordance with the context change at block 408. For example, the annotations manager 224 may perform various annotation transformation operations for the annotation objects 310-1-p, including delete operations, move operations, retrieve operations and zoom operations via the respective modules 224-1, 224-2, 224-3 and 224-4, as previously described with reference to FIG. 3. For example, the annotations manager 224 may receive an annotation object 310-1-p when disposed on the shared application object 308. The store module 224-3 of the annotations manager 224 may associate the annotation object 310-1-p with the shared application object 308, and store the annotation object 310-1-p in the SAM database 116. The store module 224-3 may retrieve the annotation objects 310-1-p from the SAM database 116 for display by the shared application view 306 when the shared application object is redisplayed by the shared application view 306. The delete module 224-1 of the annotations manager 224 may delete the annotation object 310-1-p from the shared application view 306 when the shared application object 310-1-p is no longer within the shared application view 306. The move module 224-2 of the annotations manager 224 may move the annotation object 310-1-p in accordance with movement of the shared application object 308 within the shared application view 306. The zoom module 224-4 of the annotations manager 224 may modify a size for the annotation object 310-1-p in accordance with size modifications of the shared application object 308. It may be appreciated that the modules 224-1-4 illustrate only a few examples of the type of annotation transformation operations that may be implemented by the annotations manager 224, and other annotation transformation operations may be implemented as desired for a given set of design constraints, performance constraints, and use scenarios. The embodiments are not limited in this context.

FIG. 5 illustrates a block diagram of a computing system architecture 500 suitable for implementing various embodiments, including the computing devices 110, 130 of the communications system 100. It may be appreciated that the computing system architecture 500 is only one example of a suitable computing environment and is not intended to suggest any limitation as to the scope of use or functionality of the embodiments. Neither should the computing system architecture 500 be interpreted as having any dependency or requirement relating to any one or combination of components illustrated in the exemplary computing system architecture 500.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 5, the computing system architecture 500 includes a general purpose computing device such as a computer 510. The computer 510 may include various components typically found in a computer or processing system. Some illustrative components of computer 510 may include, but are not limited to, a processing unit 520 and a memory unit 530.

In one embodiment, for example, the computer 510 may include one or more processing units 520. A processing unit 520 may comprise any hardware element or software element arranged to process information or data. Some examples of the processing unit 520 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 520 may be implemented as a general purpose processor. Alternatively, the processing unit 520 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 510 may include one or more memory units 530 coupled to the processing unit 520. A memory unit 530 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 510. The embodiments are not limited in this context.

In one embodiment, for example, the computer 510 may include a system bus 521 that couples various system components including the memory unit 530 to the processing unit 520. A system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 510 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 500. Examples of computer readable media for computing system architecture 500 may include, but are not limited to, volatile and/or nonvolatile memory such as ROM 531 and RAM 532. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 530 includes computer storage media in the form of volatile and/or nonvolatile memory such as ROM 531 and RAM 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 540 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 584 or other type of display device is also connected to the system bus 521 via an interface, such as a video processing unit or interface 582. In addition to the monitor 584, computers may also include other peripheral output devices such as speakers 587 and printer 586, which may be connected through an output peripheral interface 583.

The computer 510 may operate in a networked environment using logical connections to one or more remote computers, such as a remote computer 580. The remote computer 580 may be a personal computer (PC), a server, a router, a network PC, a peer device or other common network node, and typically includes many or all of the elements described above relative to the computer 510, although only a memory storage device 581 has been illustrated in FIG. 5 for clarity. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other technique suitable for establishing communications over the WAN 573, such as the Internet. The modem 572, which may be internal or external, may be connected to the system bus 521 via the network interface 570, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other techniques for establishing a communications link between the computers may be used. Further, the network connections may be implemented as wired or wireless connections. In the latter case, the computing system architecture 500 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the communications system 100 and/or computing system architecture 500 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
generating a shared application view for a shared application object;
associating an annotation object with the shared application object;
detecting a change in context for the shared application view or shared application object; and
transforming the annotation object in accordance with the context change.

2. The method of claim 1, comprising receiving the annotation object when disposed on the shared application object.

3. The method of claim 1, comprising deleting the annotation object from the shared application view when the shared application object is no longer within the shared application view.

4. The method of claim 1, comprising moving the annotation object in accordance with movement of the shared application object within the shared application view.

5. The method of claim 1, comprising storing the annotation object in a shared application database.

6. The method of claim 1, comprising retrieving the annotation object from a shared application database for display by the shared application view when the shared application object is redisplayed by the shared application view.

7. The method of claim 1, comprising modifying a size for the annotation object in accordance with size modifications of the shared application object.

8. An article comprising a storage medium containing instructions that if executed enable a system to:
generate a shared application view for a shared application object;
receive an annotation object when disposed on the shared application object;
detect a change in context for the shared application view; and
transform the annotation object in accordance with the context change.

9. The article of claim 8, further comprising instructions that if executed enable the system to associate an annotation object with the shared application object.

10. The article of claim 8, further comprising instructions that if executed enable the system to receive the annotation object when disposed on the shared application object.

11. The article of claim 8, further comprising instructions that if executed enable the system to delete the annotation object from the shared application view when the shared application object is no longer within the shared application view.

12. The article of claim 8, further comprising instructions that if executed enable the system to move the annotation object in accordance with movement of the shared application object within the shared application view.

13. The article of claim 8, further comprising instructions that if executed enable the system to store the annotation object in a shared application database.

14. The article of claim 8, further comprising instructions that if executed enable the system to retrieve the annotation object from a shared application database for display by the shared application view when the shared application object is redisplayed by the shared application view.

15. The article of claim 8, further comprising instructions that if executed enable the system to modify a size for the annotation object in accordance with size modifications of the shared application object.

16. An apparatus, comprising:
a processor;
a memory coupled to the processor, the memory storing a shared application manager module for execution by the processor, the shared application manager module comprising:
a client user interface component operative to generate a shared application view for a shared application object; and
an annotations manager operative to associate an annotation object with the shared application object, detect a change in context for the shared application view, and transform the annotation object in accordance with the context change.

17. The apparatus of claim 16, the annotations manager comprising a delete module operative to delete the annotation object from the shared application view when the shared application object is no longer within the shared application view.

18. The apparatus of claim 16, the annotations manager comprising a move module operative to move the annotation object in accordance with movement of the shared application object within the shared application view.

19. The apparatus of claim 16, the annotations manager comprising a store module operative to store the annotation object in a shared application database.

20. The apparatus of claim 16, the annotations manager comprising a zoom module operative to modify a size for the annotation object in accordance with size modifications of the shared application object.
